(19) United States
(12) Patent Application Publication
(10) Pub. No.: US 2011/0252426 A1
(43) Pub. Date: Oct. 13, 2011

(54) PROCESSING BATCH TRANSACTIONS

(75) Inventors: SNEHAL S. ANTANI, HYDE PARK, NY (US); NEERAJ JOSHI, MORRISVILLE, NC (US); SAJAN SANKARAN, RALEIGH, NC (US); CHRISTOPHER P. VIGNOLA, PORT JERVIS, NY (US)

(73) Assignee: INTERNATIONAL BUSINESS MACHINES CORPORATION, ARMONK, NY (US)

(21) Appl. No.: 12/756,306

(22) Filed: Apr. 8, 2010

(51) Int. Cl. G06F 9/46

(52) U.S. Cl. 718/101

(57) ABSTRACT

A batch data stream, which comprises inputs to a serial batch application program, is received. Batch code from the serial batch application program is translated into parallel code that is executable in parallel by multiple execution units. Checkpoints are applied to the batch data stream that has been received, and data between the checkpoints defines multiple threads. The multiple threads are stored in an input queue that feeds data inputs to multiple execution units. The parallel code is then executed in the multiple execution units by using the multiple threads as inputs.

### BACKGROUND

The present disclosure relates to the field of computers, and specifically to the execution of programs on computers. Still more particularly, the present disclosure relates to handling the processing of transactional batch programs.

### BRIEF SUMMARY

A computer-implemented method, system, and/or computer program product process a serial batch application program. A batch data stream, which comprises inputs to a serial batch application program that is constructed to execute its instructions serially, is received. Batch code from the serial batch application program is translated into parallel code that is executable in parallel by multiple execution units. Checkpoints are applied to the batch data stream that has been received, and data between the checkpoints defines multiple threads. The multiple threads are stored in an input queue that feeds data inputs to multiple execution units. The parallel code is then executed in the multiple execution units by using the multiple threads as inputs.

### BRIEF DESCRIPTION OF THE SEVERAL VIEWS OF THE DRAWINGS

FIG. 1 depicts an exemplary computer in which the present disclosure may be implemented;

FIG. 2 illustrates an interaction between a novel serial batch-to-parallel batch (SBTPB) transformation machine and a batch application program;

FIG. 3 depicts an interaction between an interactive application computer and one or more SBTPB transformation machines; and

FIG. 4 is a high-level flow-chart of one or more exemplary steps performed by a processor to process a batch transaction using parallel processing.

### DETAILED DESCRIPTION

As will be appreciated by one skilled in the art, the present disclosure may be embodied as a system, method or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product embodied in one or more computer-readable medium(s) having computer-readable program code embodied thereon.

Any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

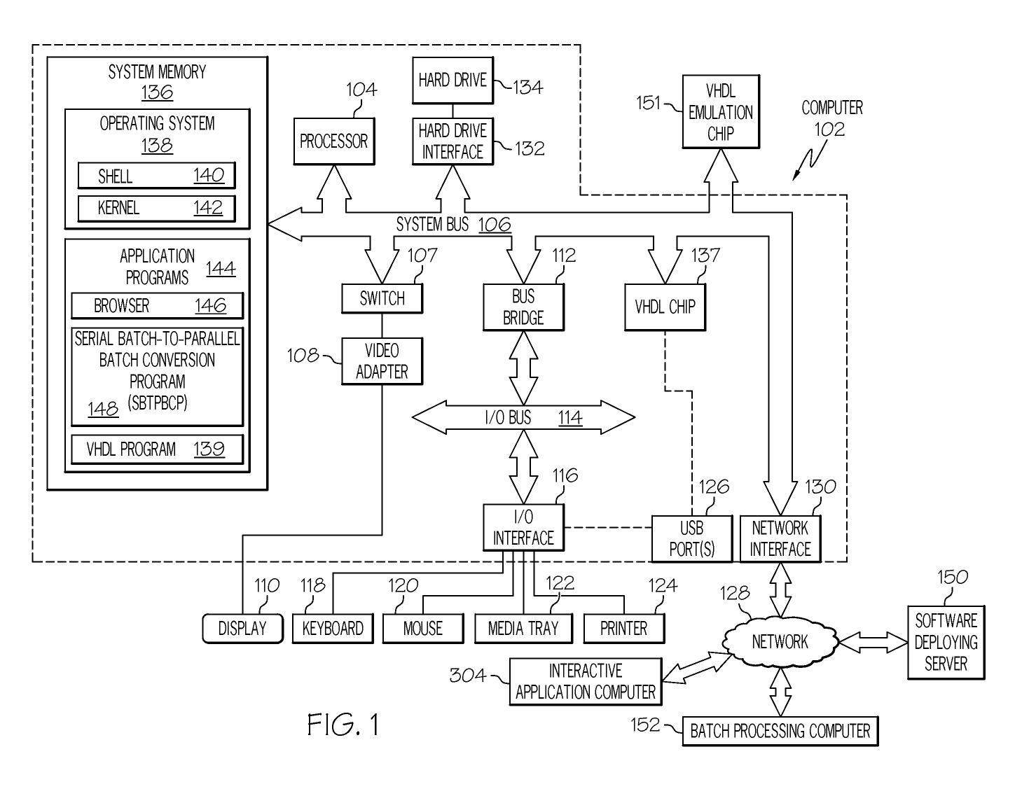

With reference now to the figures, and in particular to FIG. 1, there is depicted a block diagram of an exemplary computer 102, which may be utilized by the present disclosure. Note that some or all of the exemplary architecture, including both depicted hardware and software, shown for and within computer 102 may be utilized by software deploying server 150, and/or a batch processing computer 152, as well as interactive application computer 304.

Computer 102 includes a processor unit 104 that is coupled to a system bus 106. Processor unit 104 may utilize one or more processors, each of which has one or more processor cores. A video adapter 108, which drives/supports a display 110, is also coupled to system bus 106. In one embodiment, a switch 107 couples the video adapter 108 to the system bus 106. Alternatively, the switch 107 may couple the video adapter 108 to the display 110. In either embodiment, the switch 107 is a switch, preferably mechanical, that allows the display 110 to be coupled to the system bus 106, and thus to be functional only upon execution of instructions (e.g., batch to parallel conversion program—SBTPBCP 148 described below) that support the processes described herein.

System bus 106 is coupled via a bus bridge 112 to an input/output (I/O) bus 114. An I/O interface 116 is coupled to I/O bus 114. I/O interface 116 affords communication with various I/O devices, including a keyboard 118, a mouse 120, a media tray 122 (which may include storage devices such as CD-ROM drives, multi-media interfaces, etc.), a printer 124, and (if a VHDL chip 137 is not utilized in a manner described below), external USB port(s) 126. While the format of the ports connected to I/O interface 116 may be any known to those skilled in the art of computer architecture, in a preferred embodiment some or all of these ports are universal serial bus (USB) ports.

As depicted, computer 102 is able to communicate with a software deploying server 150, status notification server 152, and/or other status message implementing computer(s) 154 via network 128 using a network interface 130. Network 128 may be an external network such as the Internet, or an internal network such as an Ethernet or a virtual private network (VPN).

A hard drive interface 132 is also coupled to system bus 106. Hard drive interface 132 interfaces with a hard drive 134. In a preferred embodiment, hard drive 134 populates a system memory 136, which is also coupled to system bus 106. System memory is defined as a lowest level of volatile memory in computer 102. This volatile memory includes additional higher levels of volatile memory (not shown), including, but not limited to, cache memory, registers and buffers. Data that populates system memory 136 includes computer 102's operating system (OS) 138 and application programs 144.

OS 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present disclosure will equally well support other user interface modes, such as graphical, voice, gestural, etc.

As depicted, OS 138 also includes kernel 142, which includes lower levels of functionality for OS 138, including providing essential services required by other parts of OS 138 and application programs 144, including memory management, process and task management, disk management, and mouse and keyboard management.

Application programs 144 include a renderer, shown in exemplary manner as a browser 146. Browser 146 includes program modules and instructions enabling a world wide web (WWW) client (i.e., computer 102) to send and receive network messages to the Internet using hypertext transfer protocol (HTTP) messaging, thus enabling communication with software deploying server 150 and other described computer systems.

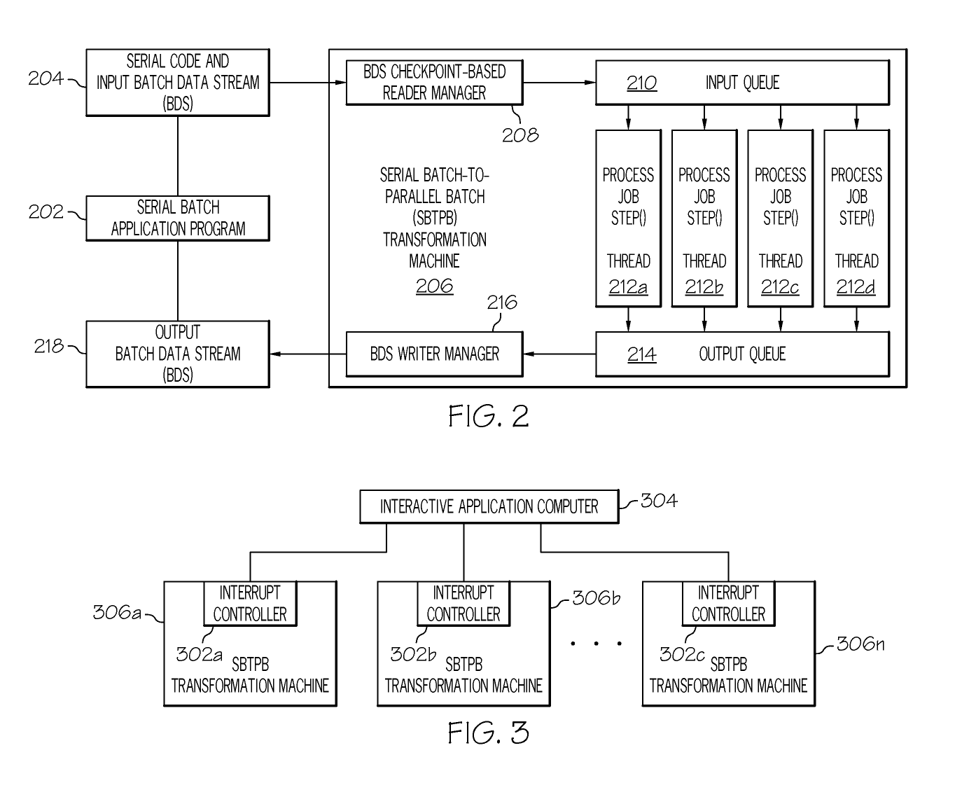

Application programs 144 in computer 102's system memory (as well as software deploying server 150's system memory) also include a serial batch-to-parallel batch conversion program (SBTPBCP) 148. SBTPBCP 148 includes code for implementing the processes described below, including those described in FIGS. 2-4. In one embodiment, computer 102 is able to download SBTPBCP 148 from software deploying server 150, including in an on-demand basis, such that the code from SBTPBCP 148 is not downloaded until runtime or otherwise immediately needed by computer 102. Note further that, in one embodiment of the present disclosure, software deploying server 150 performs all of the functions associated with the present disclosure (including execution of SBTPBCP 148), thus freeing computer 102 from having to use its own internal computing resources to execute SBTPBCP 148.

Also stored in system memory 136 is a VHDL (VHSIC hardware description language) program 139. VHDL is an exemplary design-entry language for field programmable gate arrays (FPGAs), application specific integrated circuits (ASICs), and other similar electronic devices. In one embodiment, execution of instructions from SBTPBCP 148 causes VHDL program 139 to configure VHDL chip 137, which may be an FPGA, ASIC, etc.

In another embodiment of the present disclosure, execution of instructions from SBTPBCP 148 results in a utilization of VHDL program 139 to program a VHDL emulation chip 151. VHDL emulation chip 151 may incorporate a similar architecture as described herein for VHDL chip 137. Once SBTPBCP 148 and VHDL program 139 program VHDL emulation chip 151, VHDL emulation chip 151 performs, as hardware, some or all functions described by one or more executions of some or all of the instructions found in SBTPBCP 148. That is, the VHDL emulation chip 151 is a hardware emulation of some or all of the software instructions found in SBTPBCP 148. In one embodiment, VHDL emulation chip 151 is a programmable read only memory (PROM) that, once burned in accordance with instructions from SBTPBCP 148 and VHDL program 139, is permanently transformed into a new circuitry that performs the functions needed to perform the process described below in FIGS. 2-4.

The hardware elements depicted in computer 102 are not intended to be exhaustive, but rather are representative to highlight essential components required by the present disclosure. For instance, computer 102 may include alternate memory storage devices such as magnetic cassettes, digital versatile disks (DVDs), Bernoulli cartridges, and the like. These and other variations are intended to be within the spirit and scope of the present disclosure.

With reference now to FIG. 2, an interaction between a novel serial batch-to-parallel batch (SBTPB) transformation machine and a batch application program is presented. A serial batch application program 202, which is constructed to execute its instructions serially, sends serial execution code and inputs for that serial execution code collectively as input batch data stream (BDS 204) to a serial batch-to-parallel batch (SBTPB) transformation machine 206. The input BDS 204 is received by a BDS checkpoint-based reader manager 208. The BDS checkpoint-based reader manager 208 performs several functions. Specifically, the BDS checkpoint-based reader manager 208 converts the serial code from the serial batch application program 202 into parallel code, which is executable in parallel by multiple execution units. The BDS checkpoint-based reader manager 208 also applies checkpoints to the data in the input BDS 204, and such that parsing the data into units between the checkpoints defines multiple threads that are each bounded by two checkpoints. The multiple threads are then sent to an input queue 210, which feeds the threads to multiple execution units 212a-d (where “d” is an integer). The multiple execution units 212a-d then execute the threads using the newly constructed parallel code, and send the resulting outputs to an output queue 214. In one embodiment, the output queue 214 is a write-only queue that 1) provides protection from data being improperly overwritten by unauthorized logic (i.e., logic other than the execution units 212a-d), and 2) provides random access to any of the outputs from the execution units 212a-d. In one embodiment, one of the execution units 212a-d, as well as the thread being processed thereon, is dedicated to keeping track of the context of the other threads being processed on the other execution units. This context describes any changes to code inputs and outputs that are caused by executing the parallel code. For example, if a thread on execution 212a is dependent on the output of execution thread 212b, then the dedicated context execution unit (e.g., execution unit 212d) will keep track of how these threads are related.

If all of the processes in transaction (e.g., code in a thread between two checkpoints) have been completed, then the contents of the output queue 214 are sent to a BDS writer manager 216. The BDS writer manager 216 converts the data from a parallel format back into a serial format that is usable by the serial batch application program 202. This converted output BDS 218 is then sent back to the serial batch application program 202, such that the operations performed within the SBTPB transformation machine 206 are logically concealed from the serial batch application program 202.

Note that the serial batch application program 202 may be executing on a batch processing computer 152, as shown in FIG. 1, while the SBTPB transformation machine 206 is executing on the computer 102 shown in FIG. 1. Thus, a client (batch processing computer 152) is unaware of the transformations that occurred to code and data from the serial batch application program 202, making the operations performed by the SBTPB transformation machine logically concealed from the serial batch application program.

Note that the programming described herein is all batch programming (both the serial and the parallel examples described), such that all inputs are provided at the same time as the execution code. Non-batch programming is known as interactive programming, in which executable code waits for inputs from a user (e.g., from a terminal, a webpage, etc.). Thus, with reference now to FIG. 3, assume that an interactive application computer 304 is running an interactive program (not shown) that is requesting immediate processing from computer 102. However, computer 102 (comprising one of SBTPB transformation machines 306a-n, wherein “n” is an integer, which are analogous to SBTPB transformation machine 206 shown herein in FIG. 2) is currently executing a batch job in a manner described herein in FIG. 2. An interrupt controller 302 (i.e., one of the corresponding interrupt controllers 302a-n), in response to receiving the request from the interactive application computer 304, terminates the batch parallel processing in the execution units 212a-d, empties the output queue 214, and restores the input queue 210 with the parallel code and data previously derived for the pending transaction (i.e., by retrieving it from a temporary storage buffer). The interrupt controller 302 then allows the interactive application to run on one or more of the execution units 212a-d, and returns the resulting output to the interactive application computer 304. The interrupt controller 302 then restarts the execution of the transaction thread (that was stopped by the interrupt).

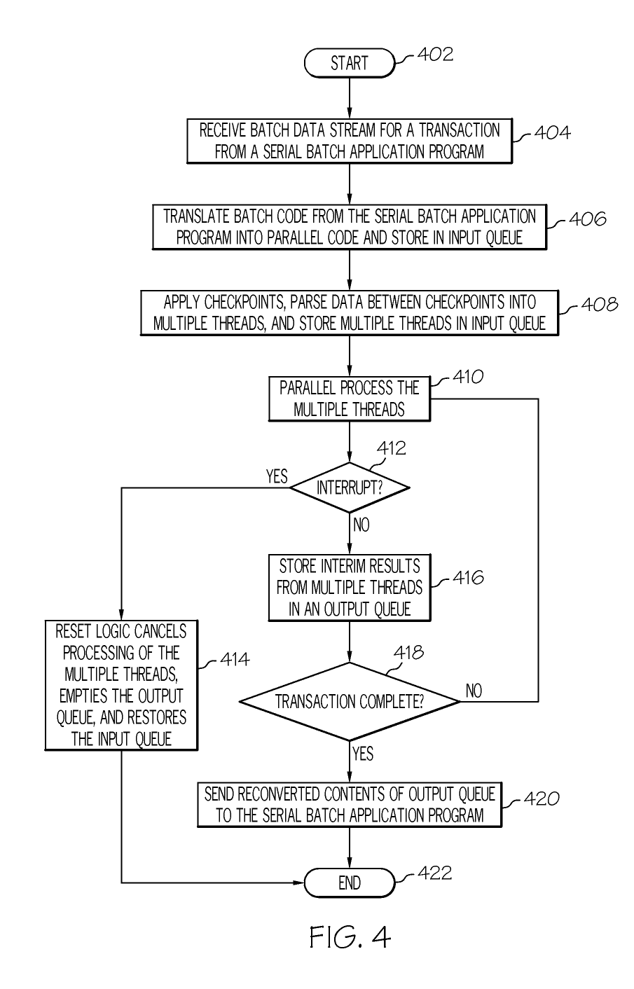

With reference now to FIG. 4, a high level flow-chart of exemplary steps taken to process a batch transaction using parallel processing is presented. After initiator block 402, a serial batch data stream is received for a transaction from a serial batch application program and stored in an input queue in the SBTPB transformation machine described herein (block 404). For example, assume that the serial batch application program reconciles bank statements at the end of each business day. A transaction (job) performed by that batch program would use the known inputs (deposits, withdrawals) from each bank account, determine if the account is overdrawn, and generate/transmit the appropriate alert if the account is overdrawn. The job is performed serially, running the same execution code using different inputs for each bank account.

As described in block 406, the serial batch code is translated into parallel code. Thus, rather than waiting for each account to be reconciled, the original serial batch code is converted into parallel batch code, which allows multiple bank accounts to be reconciled simultaneously. This conversion may be complex, depending on what, if any, interaction/dependencies exist when reconciling the different bank accounts. The parallel batch code is stored in an input queue.

The serial batch data (i.e., inputs from each bank account) are parsed into multiple threads and stored in an input queue for multiple execution units (block 408). Specifically, each batch data stream (BDS) is parsed into 1) data between two checkpoints that have been created and applied by the SBTPB transformation machine to the BDS, and/or 2) data dedicated to a particular sub job (e.g., a particular bank account).

As described in block 410, the multiple threads are then processed in parallel. If an interrupt occurs (query block 412, such as from the interactive application computer 304 described herein), then reset logic (i.e., part of the interrupt controllers 302a-n shown in FIG. 3) cancels the processing of the batch threads, and empties out (i.e., merely deletes) the output queue. After the interrupt is handled (e.g., by processing the interactive application's request for service), then the input queue is restored with the batch code/data, which was temporarily stored earlier in a buffer/register/queue.

Note that interrupts can also be caused by other events besides the interactive application described herein desiring to use the resources (i.e., the execution units) in the SBTPB transformation machine. For example, if the interactive application needs to access a database used to create the serial batch data stream, then an interrupt needs to be handled in order to avoid a collision between the batch process and online transaction processing (OLTP) such as the interactive application. For example, assume that data for the serial batch data stream is being pulled from a database of 100 records, and that a checkpoint has been defined for every 10 records. Thus, the following pseudocode would run.

```
“The sequential batch program processes data account by account.
  Checkpoint interval is 10”
  For account a from 1 to 100
    1. Read transactions from account number a
    2. Perform overdraft processing for this account
    3. Send email if there is an overdraft [Add to output buffer
    of list of account holders to send email to]
    4. a = a + 1
  if( a < checkpoint interval)
    GO TO 1.
      else
Process the output buffer (Send out all the emails)
Take a checkpoint (Save account number a to the checkpoint repository)
Go to 1.
```

In this example, if an interrupt were to occur while reading the record at position 14, then the checkpoint would have recorded that every record up to account number 10 had been processed, and thus only the processing of records at positions 11-14 would be dumped from the SBTPB transformation machine, including any records in the output buffer. Thus, when restarting the parallel processing of the BDS in the SBTPB transformation machine, the checkpoint includes the starting position from which records that make up the BDS are pulled (i.e., position 10 if the interrupt occurred after BDS data was pulled from position 9 but before any BDS data had been pulled from position 19).

If no interrupt occurs before the batch job completes (query block 412), then interim results from the multiple threads are stored in the output queue (block 416) until the entire transaction (the entire batch job) is complete (query block 418), at which time the contents of the output queue are sent back to the serial batch application program (block 420). The process ends at terminator block 422 with the resources of SBTPB transformation machine being released.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of various embodiments of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

Note further that any methods described in the present disclosure may be implemented through the use of a VHDL (VHSIC Hardware Description Language) program and a VHDL chip. VHDL is an exemplary design-entry language for Field Programmable Gate Arrays (FPGAs), Application Specific Integrated Circuits (ASICs), and other similar electronic devices. Thus, any software-implemented method described herein may be emulated by a hardware-based VHDL program, which is then applied to a VHDL chip, such as a FPGA.

Having thus described embodiments of the disclosure of the present application in detail and by reference to illustrative embodiments thereof, it will be apparent that modifications and variations are possible without departing from the scope of the disclosure defined in the appended claims.

What is claimed is:

1. A computer-implemented method of processing a serial batch application program, the computer-implemented method comprising:
receiving a batch data stream, wherein the batch data stream is data used as inputs to a serial batch application program, and wherein the serial batch application program is constructed to execute its instructions serially;
a processor translating batch code from the serial batch application program into parallel code, wherein the parallel code is executable in parallel by multiple execution units;
applying checkpoints to the batch data stream that has been received;
parsing the batch data stream into multiple threads, wherein each of the multiple threads is bounded by two of the checkpoints;
storing the multiple threads in an input queue, wherein the input queue feeds data inputs to multiple execution units; and
executing the parallel code in the multiple execution units by using the multiple threads as inputs.

2. The computer-implemented method of claim 1, further comprising:
storing, in an output queue, interim outputs from the executing of the parallel code;
receiving an interrupt from an interactive program, wherein the interrupt requests immediate processing of code from the interactive program; and
in response to receiving the interrupt, cancelling execution of the parallel code, emptying the output queue, and restoring the input queue with threads that have not completed parallel execution.

3. The computer-implemented method of claim 1, wherein the batch data stream is retrieved from a serial database, and wherein the checkpoints describe a position in the serial database from which a current datum is retrieved.

4. The computer-implemented method of claim 1, wherein the operations in claim 1 are performed by a serial batch-to-parallel batch (SBTPB) transformation machine, and wherein the operations performed by the SBTPB transformation machine are logically concealed from the serial batch application program.

5. The computer-implemented method of claim 1, wherein the output queue is a random access write-only queue.

6. The computer-implemented method of claim 1, further comprising:
dedicating one of the multiple execution units to track context for the multiple threads, wherein the context describes any changes to code inputs and outputs that are caused by executing the parallel code.

7. A system comprising a serial batch-to-parallel batch (SBTPB) transformation hardware machine, the SBTPB transformation hardware machine comprising:
receiving hardware for receiving a batch data stream, wherein the batch data stream is data that is used as inputs to a serial batch application program, and wherein the serial batch application program is constructed to execute its instructions serially; and
a processor configured to:
translate batch code from the serial batch application program into parallel code, wherein the parallel code is executable in parallel by multiple execution units;
apply checkpoints to the batch data stream that has been received;
parse the batch data stream into multiple threads, wherein each of the multiple threads is bounded by two of the checkpoints;
an input queue for storing the multiple threads; and
multiple execution units for executing parallel code by using the multiple threads as inputs.

8. The system of claim 7, wherein the SBTPB transformation hardware machine further comprises:
an output queue for storing interim outputs from the executing of the parallel code;
an interrupt controller for receiving an interrupt from an interactive program, wherein the interrupt requests immediate processing of code from the interactive program; and
reset logic for, in response to receiving the interrupt, cancelling execution of the parallel code, emptying the output queue, and restoring the input queue with threads that have not completed parallel execution.

9. The system of claim 7, wherein the batch data stream is retrieved from a serial database, and wherein the checkpoints describe a position in the serial database from which a current datum is retrieved.

10. The system of claim 7, wherein operations performed by the SBTPB transformation machine are logically concealed from the serial batch application program.

11. The system of claim 7, wherein the output queue is a random access write-only queue.

12. The system of claim 7, wherein one of the multiple execution units is dedicated to tracking context for the multiple threads, wherein the context describes any changes to code inputs and outputs that are caused by executing the parallel code.

13. A computer program product comprising a computer readable storage medium embodied therewith, the computer readable storage medium comprising:
computer readable program code configured to receive a batch data stream, wherein the batch data stream is data that is used as inputs to a serial batch application program, and wherein the serial batch application program is constructed to execute its instructions serially;
computer readable program code configured to translate batch code from the serial batch application program into parallel code, wherein the parallel code is executable in parallel by multiple execution units;
computer readable program code configured to apply checkpoints to the batch data stream that has been received;
computer readable program code configured to parse the batch data stream into multiple threads, wherein each of the multiple threads is bounded by two of the checkpoints;
computer readable program code configured to store the multiple threads in an input queue, wherein the input queue feeds data inputs to multiple execution units; and
computer readable program code configured to execute the parallel code in the multiple execution units by using the multiple threads as inputs.

14. The computer program product of claim 13, further comprising:
computer readable program code configured to store, in an output queue, interim outputs from the executing of the parallel code;
computer readable program code configured to receive an interrupt from an interactive program, wherein the interrupt requests immediate processing of code from the interactive program; and
computer readable program code configured to, in response to receiving the interrupt, cancel execution of the parallel code, empty the output queue, and restore the input queue with threads that have not completed parallel execution.

15. The computer program product of claim 13, wherein the batch data stream is retrieved from a serial database, and wherein the checkpoints describe a position in the serial database from which a current datum is retrieved.

16. The computer program product of claim 13, wherein the operations in claim 11 are performed by a serial batch-to-parallel batch (SBTPB) transformation machine, and wherein the operations performed by the SBTPB transformation machine are logically concealed from the serial batch application program.

17. The computer program product of claim 13, wherein the output queue is a random access write-only queue.

18. The computer program product of claim 13, further comprising:
computer readable program code configured to reserve one of the multiple execution units for tracking context for the multiple threads, wherein the context describes any changes to code inputs and outputs that are caused by executing the parallel code.
